(19) United States
(12) Patent Application Publication
(10) Pub. No.: US 2026/0042112 A1
(43) Pub. Date: Feb. 12, 2026

(54) MULTI-PUMP FLUID SPRAYING SYSTEM WITH METERING VALVES

(71) Applicant: Gerald Vess, Livingston, TX (US)

(72) Inventor: Gerald Vess, Livingston, TX (US)

(21) Appl. No.: 18/795,255

(22) Filed: Aug. 6, 2024

(51) Int. Cl. B05B 12/14; B05B 9/04

(52) U.S. Cl. CPC B05B 12/1418; B05B 9/0406; B05B 9/0409

(57) ABSTRACT

A fluid spraying system includes a manifold, four pumps connected in parallel to the manifold, a control unit configured to control air supply to the four pumps, a plurality of metering valves connected to the manifold for adjusting mixture of different chemicals, and a spray gun connected to the manifold for dispensing fluid. The control unit is configured to selectively activate and deactivate individual pumps of the four pumps. The four pumps are air-operated double diaphragm pumps. The system further includes a warning module configured to alert a user of a problem with a specific pump. The manifold and pumps are constructed of plastic and rubber materials. The control unit coordinates power to each pump based on user needs and internal system conditions, and adjusts flow rate of fluid to the spray gun by controlling the activation of the pumps.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to fluid spraying systems, and more particularly to a multi-pump fluid spraying system with metering valves for efficient and controlled dispensing of chemical mixtures.

### 2) Description of Related Art

Fluid spraying systems are widely used in various industries for applications such as cleaning, pest control, and botanical treatments. These systems typically involve the use of pumps to dispense fluids or chemical mixtures through spray nozzles or guns. The ability to efficiently and accurately dispense fluids is crucial for many industrial and commercial operations.

Air-operated double diaphragm (AODD) pumps are commonly employed in fluid spraying systems due to their durability and reliability. These pumps utilize compressed air to drive the pumping action, making them suitable for handling a wide range of fluids, including corrosive chemicals. However, AODD pumps can be susceptible to stalling issues, particularly when moisture enters the air side of the pump, causing the air valve to stick and temporarily halt pumping action.

In many applications, it is desirable to have the ability to adjust the mixture ratios of different chemicals on-site. This flexibility allows operators to tailor the fluid composition to specific job requirements without the need for pre-mixing large volumes of solution. Additionally, the ability to transport concentrated chemicals and mix them at the point of use can enhance safety by reducing the volume of hazardous materials being transported.

The size and efficiency of fluid spraying systems are important considerations in many industries. Systems that require large air compressors or consume significant amounts of fuel or electricity can be impractical or cost-prohibitive in certain settings. Furthermore, systems that are prone to overheating or require frequent maintenance can lead to downtime and reduced productivity.

Corrosion resistance is another critical factor in the design of fluid spraying systems, particularly when working with aggressive chemicals. Systems that are susceptible to rust or degradation may have shorter operational lifespans and require more frequent replacement of components.

As industries continue to seek more efficient, flexible, and durable fluid spraying solutions, there remains a need for improved systems that can address these various challenges while maintaining ease of use and reliability.

### BRIEF SUMMARY OF THE INVENTION

According to an aspect of the present disclosure, a fluid spraying system is provided. The fluid spraying system includes a manifold assembly configured to connect multiple pumps in parallel. The system includes four pumps connected to the manifold assembly. The system also includes three metering valves connected to the manifold assembly; each metering valve configured to control a mixture of different chemicals. The system further includes a pump inlet manifold connected to an inlet of each of the four pumps, a pump outlet manifold connected to an outlet of each of the four pumps, and a pump air supply manifold connected to an air supply connection of each of the four pumps. The system also includes a control unit configured to control air supply to the four pumps.

According to other aspects of the present disclosure, the fluid spraying system may include one or more of the following features. The control unit may be further configured to turn the pumps on and off in different configurations to control flow rate of fluid to a spray gun or spray wand. The system may further include a warning module configured to alert a user if there is a problem with a specific pump. The manifold assembly and pumps may be constructed of plastic and rubber materials to prevent rusting. The system may be configured to operate using a 5 cubic feet per minute (CFM) air compressor to achieve a flow rate of 20 gallons per minute. Each metering valve may be connected at one end to a container having a specific chemical and at an opposite end to a metering valve manifold connected to the pump inlet manifold. The metering valves may be configured to allow changing of chemical mixtures as they flow through the system, enabling on-demand mixing of solutions.

According to another aspect of the present disclosure, a method of operating a fluid spraying system is provided. The method includes providing a manifold assembly with four pumps connected in parallel. The method also includes supplying air to the four pumps through a pump air supply manifold. The method further includes controlling a mixture of different chemicals using three metering valves connected to the manifold assembly. The method also includes directing fluid from the four pumps through a pump outlet manifold. The method further includes controlling air supply to the four pumps using a control unit to adjust fluid flow rate.

According to other aspects of the present disclosure, the method may include one or more of the following features. The method may further include alerting a user if there is a problem with a specific pump using a warning module. Controlling the mixture of different chemicals may comprise connecting each metering valve at one end to a container having a specific chemical and at an opposite end to a metering valve manifold connected to a pump inlet manifold. The method may further include changing chemical mixtures on-demand as they flow through the system. Supplying air to the four pumps may comprise using a 5 cubic feet per minute (CFM) air compressor to achieve a flow rate of 20 gallons per minute. The method may further include turning the pumps on and off in different configurations to control flow rate of fluid to a spray gun or spray wand. Controlling air supply to the four pumps may comprise coordinating power to each pump based on user needs and internal problems with the system.

According to another aspect of the present disclosure, a fluid spraying apparatus is provided. The fluid spraying apparatus includes a manifold assembly. The apparatus also includes four air-operated double diaphragm pumps connected in parallel to the manifold assembly. The apparatus further includes three metering valves connected to the manifold assembly; each metering valve configured to control a mixture of different chemicals. The apparatus also includes a pump inlet manifold, a pump outlet manifold, a pump air supply manifold, and a spray gun connected to the pump outlet manifold.

According to other aspects of the present disclosure, the fluid spraying apparatus may include one or more of the following features. The apparatus may further include a control unit configured to control air supply to the four air-operated double diaphragm pumps. The control unit may be further configured to turn the pumps on and off in different configurations to control flow rate of fluid to the spray gun. Each metering valve may be connected at one end to a container having a specific chemical and at an opposite end to a metering valve manifold connected to the pump inlet manifold. The metering valves may be configured to allow changing of chemical mixtures as they flow through the apparatus, enabling on-demand mixing of solutions.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a schematic diagram of the spray system according to the present invention;

FIG. 2 is a perspective view of a spray system contained in a system housing;

FIG. 3 is a cutaway perspective view of the spray system shown in FIG. 2 with a housing lid or cover; and

FIG. 4 is a cutaway perspective view of another embodiment of a spray system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure provides a system for spraying fluids, also referred to as a spraying system. This system may be utilized for dispensing a variety of fluids, including but not limited to, chemicals for washing, botanical use, and pest control. The spraying system may comprise a manifold, which may be used for connecting four pumps in parallel. This configuration may enhance the spray volume and reduce the likelihood of system stalling, a common issue that arises when moisture infiltrates the air side of an air pump, causing the air valve to stick and the pump to temporarily cease operation.

The spraying system may also include three metering valves, which may allow for the adjustment of the chemical mixture as it passes through the system. This feature may be particularly beneficial for professional users, such as pest control companies, who may need to mix large volumes of solution on-site. By enabling the user to mix the solution as it is dispensed from the spray gun, the need to transport large quantities of pre-mixed, potentially hazardous chemicals may be reduced.

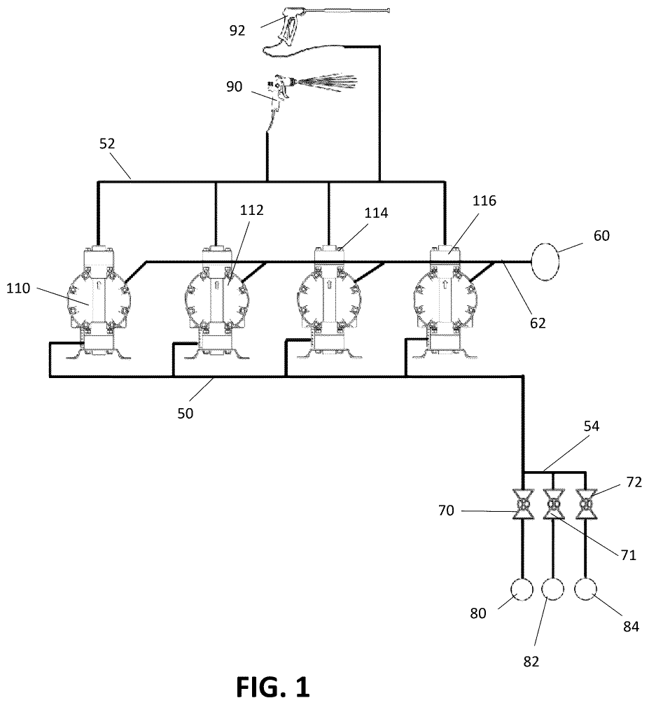

FIG. 1 is a schematic diagram of the spray system according to the present invention. The system is a fluid spraying system 100 including four pumps, each of the four pumps having a pump inlet, a pump outlet and an air supply connection. The fluid spraying system 100 includes a plurality of metering valves 70, 71, 72 connected to a metering valve manifold 54, each metering valve for controlling flow of a chemical through chemical ports 180, 182, 184. The fluid spraying system 100 includes a pump inlet manifold 50 connected to the pump inlet of each of the four pumps, a pump outlet manifolds 52 connected to the pump outlet of each of the four pumps and a pump air supply manifold 62 connected to the air supply connection of each of the four pumps. The fluid spraying system 100 includes a control unit 498 (FIG. 4) for controlling the air supply to the four pumps. The control unit 498 may be used to control on/off functions, metering and alarm functions. The fluid spraying system of claim 1, wherein the control unit turns the pumps on and off in different configurations to control flow rate of fluid to a spray gun 90 or spray wand 92. The fluid spraying system includes a warning module configured to alert a user if there is a problem with a specific pump. The warning module may be a part of the control unit or control system. The manifold assembly and pumps are constructed of plastic and rubber materials to prevent rusting. The system preferably operates using about 5 cubic feet per minute to achieve a flow rate of 20 gallons per minute and requires a compressor able to deliver about 5 cubic feet per minute. Each metering valve is connected at one end to a container having a specific chemical and at an opposite end to a metering valve manifold connected to the pump inlet manifold. The metering valves allow changing of chemical mixtures as they flow through the system, enabling on-demand mixing of solutions.

In some aspects, the operation of the fluid spraying system may involve supplying air to the four pumps through a pump air supply manifold. The pump air supply manifold may be connected to an air supply connection of each of the four pumps, facilitating the delivery of air to the pumps. This configuration may allow for efficient operation of the pumps, contributing to the overall performance of the fluid spraying system.

In some cases, the fluid from the four pumps may be directed through a pump outlet manifold. The pump outlet manifold may be connected to a pump outlet on each pump, enabling the fluid to be channeled from the pumps to the desired location, such as a spray gun or spray wand. This arrangement may provide for controlled and efficient fluid delivery, enhancing the effectiveness of the fluid spraying system.

In some aspects, the control unit of the fluid spraying system may be configured to turn the pumps on and off in different configurations to control the flow rate of fluid to a spray gun or spray wand. This may allow for precise control over the volume and speed of fluid being sprayed, catering to the specific needs of the user or the requirements of the task at hand. The control unit may coordinate the power to each pump based on user needs and internal problems with the system, further enhancing the flexibility and reliability of the fluid spraying system.

In some cases, the fluid spraying system may be configured to operate in a continuous mode, where all four pumps are active simultaneously, or in a staggered mode, where the pumps are activated in a sequential or alternating manner. This flexibility in operation may allow for a wide range of fluid flow rates, accommodating a variety of spraying tasks and user preferences.

In other aspects, the fluid spraying system may include a warning module that alerts a user if there is a problem with a specific pump. This feature may provide real-time monitoring of the system's performance, enabling prompt detection and resolution of potential issues, thereby enhancing the reliability and longevity of the fluid spraying system.

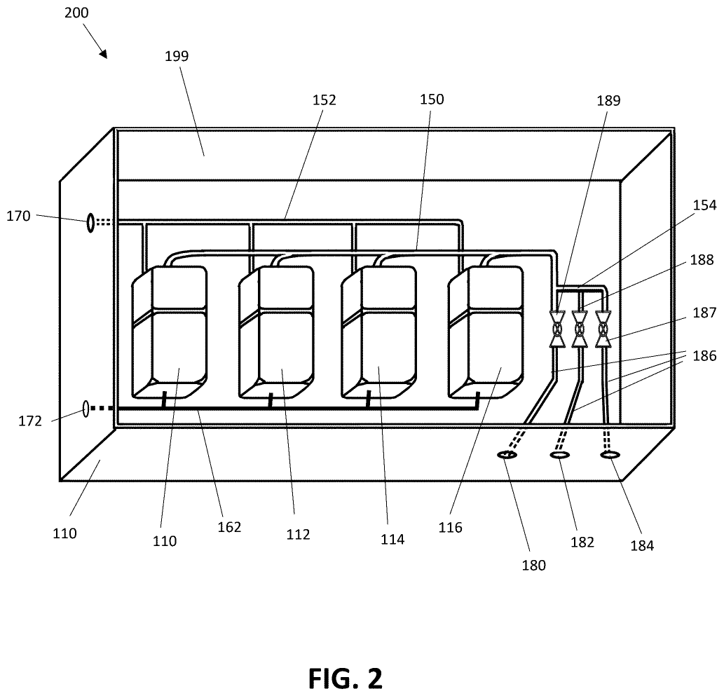

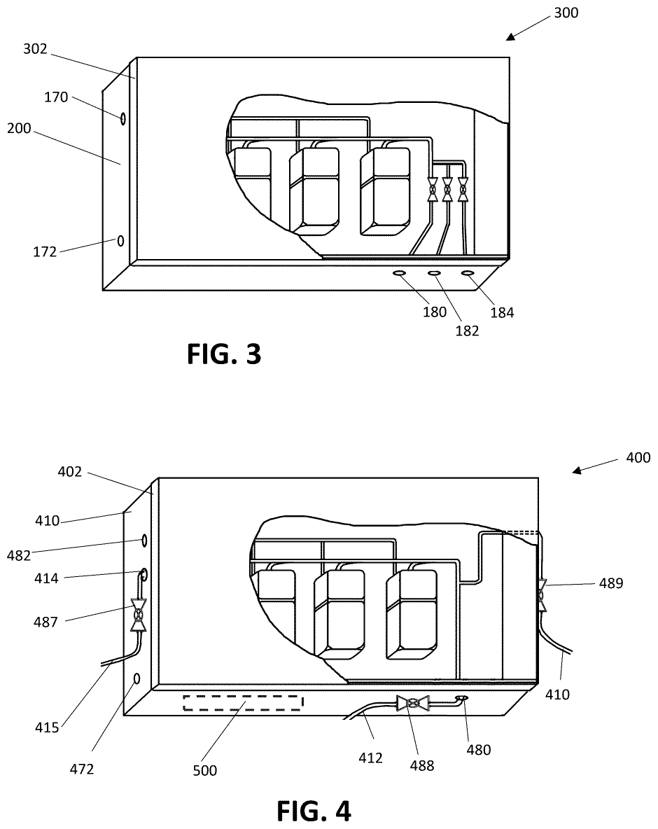

As shown in the perspective view of FIG. 2, a spray system 100 contained in a system housing 199 is a fluid spraying system which provides efficient and controlled dispensing of chemicals. The spray system 100 includes four pumps 110, 112, 114, 116 with each of the four pumps having a pump inlet, a pump outlet and an air supply connection. The spray system 100 includes a plurality of metering valves 187, 188, 189 connected to a metering valve manifold 154, each metering valve for controlling flow of a chemical through chemical ports 180, 182, 184. a pump inlet manifold connected to the pump inlet of each of the four pumps. The spray system 100 includes a pump outlet manifold 152 connected to the pump outlet of each of the four pumps and a pump air supply manifold 162 connected to the air supply connection of each of the four pumps and the system air supply inlet port 172. The spray system 100 includes a control unit for controlling the air supply to the four pumps. The four pumps connected in parallel serves to facilitate increased spray volume and increase reliability. The pumps, when operated in parallel, may reduce the likelihood of system stalls, enhancing the reliability of the system. The control unit may regulate the air supply to the pumps, enabling precise control over the operation of the system. The metering valves, connected to the manifold, may allow for adjustment of the mixture of different chemicals, providing flexibility in the composition of the dispensed fluid. The spray gun, connected to the manifold, may be used for dispensing the fluid. Together, these components may work in harmony to provide a fluid spraying system that is versatile, efficient, and reliable. FIG. 3 is a cutaway perspective view 300 of the spray system in FIG. 2 showing a housing lid 302 or cover.

FIG. 4 is a cutaway perspective view of another embodiment of a spray system and shows a spray system 400 having the metering valves 487, 488, 489 more accessible by being attached to the outside of the system housing 410 whereby the lid 402 no longer impedes use of the metering valves. Pressurized fluid is available at outlet port 482 for supply to a spray gun or spray wand. The air supply for providing power to the pumps is connected to air supply port 472. Housing openings 480, 414 allow meter valve lines to enter the housing while the chemicals for pressurization are available at valve inlets 415, 410, 412. The system controller 50 is disposed in the housing 410 and includes pressure sensors, current sensors, voltage sensors, leak sensors or any combination thereof for control and monitoring of the spray system.

In addition, the spraying system may be designed to operate efficiently with a smaller air compressor, potentially achieving a flow rate of 20 gallons per minute (GPM) with a 5 cubic feet per minute (CFM) compressor. This efficiency may result in a smaller system footprint compared to other air pump systems, potentially reducing the space required for operation and storage. Furthermore, the spraying system may be capable of continuous operation without overheating or experiencing other issues, potentially leading to significant savings in fuel or electricity.

The spraying system may also offer the flexibility to spray at full flow or as a mist, and may allow the user to release the trigger for extended periods without causing damage to the pump or spray hoses. Constructed from plastic and rubber, the spraying system may resist rusting, potentially extending its lifespan and durability. Despite the potential for leaks if excessive air pressure is applied, the pumps may continue to function, reducing the likelihood of operational interruptions.

In summary, the spraying system described in this disclosure may offer a durable, efficient, and user-friendly solution for dispensing a variety of fluids across multiple industries. Its design may allow for controlled fluid dispensing, potential reduction in chemical usage, and a smaller system footprint, among other benefits.

In some cases, the fluid spraying apparatus may include a control unit configured to control the air supply to a plurality of pumps. This control unit may be an electronic or mechanical device capable of regulating the air supply to the pumps, thereby controlling the operation of the system. The ability to control the air supply to the pumps may allow for precise control over the operation of the system, enhancing its versatility and adaptability to various usage scenarios.

In some embodiments, the control unit may be configured to selectively activate and deactivate individual pumps of the plurality of pumps. This feature may allow for precise control over the flow rate of fluid to the spray gun or other dispensing device. By selectively activating and deactivating individual pumps, the system may be able to adjust the flow rate of fluid based on user needs and internal system conditions. This may provide a high degree of flexibility and control, making the system suitable for a wide range of applications.

In conclusion, the fluid spraying system may offer a number of key advantages, including a manifold for increased spray volume and reduced system stalls, a control unit for precise control over the air supply to the pumps, and the ability to selectively activate and deactivate individual pumps for precise control over the flow rate of fluid. These features may make the fluid spraying system versatile, efficient, and reliable, suitable for a wide range of applications.

In some aspects, the control unit of the fluid spraying system may be configured to coordinate power to each pump based on user needs and internal system conditions. This coordination of power may involve adjusting the air supply to each pump, thereby controlling the operation of each pump. For instance, if a user requires a higher flow rate of fluid, the control unit may increase the air supply to the pumps, resulting in an increased flow rate of fluid to the spray gun. Conversely, if a user requires a lower flow rate of fluid, the control unit may decrease the air supply to the pumps, resulting in a decreased flow rate of fluid to the spray gun.

In addition to user needs, the control unit may also coordinate power to each pump based on internal system conditions. For example, if a specific pump is experiencing a problem, such as a stall or a leak, the control unit may decrease or cut off the air supply to that pump, thereby preventing further damage to the pump and maintaining the overall operation of the system. In some cases, the control unit may also activate a warning module to alert the user of the problem with the specific pump.

In other aspects, the control unit may coordinate power to each pump in a different manner. For instance, the control unit may be configured to activate and deactivate individual pumps in any configuration to control the flow rate of fluid to the spray gun or spray wand. This may allow for a more precise control over the flow rate of fluid, enabling the user to adjust the flow rate according to their specific needs. In some cases, the control unit may also coordinate power to each pump based on other factors, such as the type of fluid being sprayed, the ambient temperature, or the pressure within the system.

In some aspects, the fluid spraying system may comprise a manifold. The manifold may serve as a central hub for the connection of various components of the system. In some cases, the manifold may be designed to facilitate the connection of multiple pumps, metering valves, and a spray gun, among other components.

In some embodiments, the fluid spraying system may include four pumps connected in parallel to the manifold. The parallel configuration of the pumps may enhance the overall performance of the system by increasing the spray volume and reducing the likelihood of system stalling. In some cases, the four pumps may operate independently of each other, such that the failure or stalling of one pump does not affect the operation of the other pumps. This configuration may ensure a continuous and uninterrupted operation of the spraying system.

In some aspects, the fluid spraying system may comprise three metering valves connected to the manifold. These metering valves may allow for the adjustment of the mixture ratios of different chemicals as they pass through the system. In some cases, each metering valve may be associated with a specific chemical or fluid, and the user may adjust the flow rate of each chemical or fluid independently. This feature may provide the user with the flexibility to customize the chemical mixture according to specific needs or requirements.

In some embodiments, the fluid spraying system may include a spray gun connected to the manifold. The spray gun may serve as the dispensing outlet for the fluid mixture. In some cases, the spray gun may be designed to dispense the fluid mixture at different flow rates or in different forms, such as a full flow or a mist. The spray gun may also include a trigger mechanism that allows the user to control the dispensing of the fluid mixture. In some aspects, the spray gun may be designed to withstand extended periods of non-use without causing damage to the pump or spray hoses.

In some aspects, the manifold may serve as a central hub for the connection of various components of the system. The manifold may be designed to facilitate the connection of multiple pumps, metering valves, and a spray gun, among other components. The manifold may be configured to distribute the fluid from the pumps to the metering valves and ultimately to the spray gun. This configuration may allow for a seamless flow of fluid through the system, potentially enhancing the efficiency and performance of the spraying system.

In some cases, the manifold may be constructed from materials that are resistant to corrosion and wear, such as plastic or rubber. This may extend the lifespan of the manifold and, by extension, the overall spraying system. The manifold may also be designed to withstand the pressures generated by the pumps and the metering valves, ensuring the stability and reliability of the system.

In some embodiments, the manifold may be configured to connect four pumps in parallel. This configuration may increase the spray volume and reduce the likelihood of system stalling. The parallel configuration of the pumps may allow each pump to operate independently, such that the failure or stalling of one pump does not affect the operation of the other pumps. This may ensure a continuous and uninterrupted operation of the spraying system.

In some aspects, the manifold may also be configured to connect three metering valves. These metering valves may allow for the adjustment of the mixture ratios of different chemicals as they pass through the system. The manifold may distribute the fluid from the pumps to the metering valves, where the mixture ratios of the chemicals may be adjusted according to the specific needs or requirements of the user.

In some cases, the manifold may be configured to connect a spray gun. The spray gun may serve as the dispensing outlet for the fluid mixture. The manifold may distribute the fluid from the metering valves to the spray gun, allowing the user to dispense the fluid mixture at different flow rates or in different forms, such as a full flow or a mist.

In some embodiments, the spraying system may be used for spraying various fluids. These fluids may include, but are not limited to, chemicals for washing, botanical use, and pest control. The manifold, in conjunction with the pumps, metering valves, and spray gun, may allow for the efficient and controlled dispensing of these fluids.

In some aspects, the fluid spraying system may be configured to prevent stalling by utilizing the four pumps connected in parallel. Stalling, a common issue in fluid spraying systems, may occur when moisture infiltrates the air side of an air pump, causing the air valve to stick and the pump to temporarily cease operation. By connecting the four pumps in parallel, the fluid spraying system may significantly reduce the likelihood of stalling. This is because the chances of all four pumps stalling simultaneously are very unlikely.

In some cases, each of the four pumps may operate independently of each other. This independent operation may ensure that the failure or stalling of one pump does not affect the operation of the other pumps. Consequently, this configuration may ensure a continuous and uninterrupted operation of the spraying system, even in the event of a single pump stalling or failing.

In some embodiments, the four pumps may be connected to the manifold in a parallel configuration. This configuration may allow each pump to contribute to the overall spray volume, potentially enhancing the performance of the spraying system. Furthermore, the parallel configuration of the pumps may allow for a more efficient distribution of fluid through the system, potentially reducing the likelihood of system stalling.

In some aspects, the four pumps may be designed to withstand the pressures generated by the fluid and the air compressor. This may ensure the stability and reliability of the spraying system, even during continuous operation. The pumps may also be constructed from materials that are resistant to corrosion and wear, such as plastic or rubber, potentially extending the lifespan of the pumps and, by extension, the overall spraying system.

In some cases, the four pumps may be designed to operate efficiently with a smaller air compressor. This may allow the fluid spraying system to achieve a flow rate of 20 gallons per minute using a 5 cubic feet per minute air compressor. This efficiency may result in a smaller system footprint compared to other air pump systems, potentially reducing the space required for operation and storage.

In some embodiments, the fluid spraying system may include three metering valves connected to the manifold. These metering valves may allow for the adjustment of the mixture ratios of different chemicals as they pass through the system. This feature may provide the user with the flexibility to customize the chemical mixture according to specific needs or requirements. For instance, a pest control company may have a concentrated chemical that can be diluted to create a large volume of solution. Instead of pre-mixing the solution and transporting a large volume of potentially hazardous chemicals, the user may carry the concentrated chemical and dilute it on-site using the metering valves. This on-the-fly mixing of chemicals may reduce the need to carry large volumes of pre-mixed solutions, potentially enhancing the safety and convenience of the operation.

In some cases, each metering valve may be associated with a specific chemical or fluid. The user may adjust the flow rate of each chemical or fluid independently, allowing for precise control over the composition of the fluid mixture. This may be particularly beneficial in situations where the optimal mixture ratio varies depending on the specific application or environmental conditions.

In some aspects, the metering valves may be designed to withstand the pressures generated by the pumps and the fluid. This may ensure the stability and reliability of the fluid spraying system, even during continuous operation. The metering valves may also be constructed from materials that are resistant to corrosion and wear, such as plastic or rubber, potentially extending the lifespan of the metering valves and, by extension, the overall spraying system.

In some embodiments, the metering valves may be connected to the manifold in a configuration that allows for efficient distribution of fluid from the pumps to the metering valves. This configuration may allow for a seamless flow of fluid through the system, potentially enhancing the efficiency and performance of the spraying system. Furthermore, the configuration of the metering valves may allow for a more efficient mixing of chemicals, potentially reducing the likelihood of system stalling.

In some aspects, the fluid spraying system may include a spray gun connected to the manifold. The spray gun may serve as the dispensing outlet for the fluid mixture. The spray gun may be designed to dispense the fluid mixture in different forms, such as a full flow or a mist. This flexibility in dispensing forms may allow the user to adjust the spray according to specific needs or requirements. For instance, a full flow may be used for applications requiring a large volume of fluid, while a mist may be used for applications requiring a more delicate or controlled application of fluid.

In some cases, the spray gun may include a trigger mechanism that allows the user to control the dispensing of the fluid mixture. The trigger mechanism may be designed to withstand extended periods of non-use without causing damage to the pump or spray hoses. This feature may provide the user with the flexibility to pause the spraying operation as needed, without the risk of damaging the system. For instance, the user may release the trigger for extended periods during breaks or when moving between different spraying locations, without causing issues such as overheating or pump damage.

In some embodiments, the spray gun may be connected to the manifold in a configuration that allows for efficient distribution of fluid from the metering valves to the spray gun. This configuration may allow for a seamless flow of fluid through the system, potentially enhancing the efficiency and performance of the spraying system. Furthermore, the configuration of the spray gun may allow for a more efficient dispensing of the fluid mixture, potentially reducing the likelihood of system stalling.

In some aspects, the spray gun may be constructed from materials that are resistant to corrosion and wear, such as plastic or rubber. This may extend the lifespan of the spray gun and, by extension, the overall spraying system. The spray gun may also be designed to withstand the pressures generated by the fluid and the air compressor, ensuring the stability and reliability of the system, even during continuous operation.

In some aspects, the fluid spraying system may be capable of continuous operation without overheating. This may be due to the parallel configuration of the four pumps, which may distribute the workload evenly among them, potentially reducing the strain on any single pump and thereby minimizing the risk of overheating. This feature may allow the fluid spraying system to operate for extended periods, such as an entire day, without experiencing issues related to overheating. This continuous operation capability may be particularly beneficial in industries or applications where prolonged spraying operations are required.

In some cases, the fluid spraying system may consume less fuel or electricity compared to other systems. This may be due to the efficient design of the system, which may include the use of a smaller air compressor and the parallel configuration of the pumps. The smaller air compressor may require less power to operate, potentially reducing the electricity or fuel consumption of the system. Furthermore, the parallel configuration of the pumps may enhance the overall efficiency of the system, potentially further reducing the energy consumption. This reduced energy consumption may result in significant cost savings, particularly in industries or applications where the fluid spraying system is used frequently or continuously.

In some embodiments, the fluid spraying system's ability to operate without overheating and its lower energy consumption may contribute to its smaller footprint compared to other systems. The reduced energy requirements may allow for the use of a smaller air compressor, which may in turn reduce the overall size of the system. This smaller footprint may make the fluid spraying system more suitable for use in environments with limited space, such as small workshops or mobile units.

In some aspects, the fluid spraying system's ability to run continuously without overheating and its lower energy consumption may also contribute to its durability and longevity. The reduced strain on the system components, such as the pumps and the air compressor, may result in less wear and tear, potentially extending the lifespan of the system. This durability and longevity may make the fluid spraying system a cost-effective solution for various industries and applications.

In some aspects, the fluid spraying system may be constructed from materials such as plastic and rubber. These materials may be chosen for their resistance to corrosion, which can be a common issue in systems that frequently come into contact with various chemicals or fluids. The use of plastic and rubber materials may prevent the occurrence of rust, potentially extending the lifespan of the fluid spraying system.

In some cases, the components of the fluid spraying system, including the manifold, the pumps, the metering valves, and the spray gun, may all be made from plastic and rubber materials. This uniform use of materials may ensure consistent resistance to corrosion across the entire system.

In some embodiments, the plastic and rubber materials used in the construction of the fluid spraying system may also contribute to its durability. These materials may be resistant to wear and tear, potentially enhancing the system's ability to withstand continuous operation and exposure to various chemicals or fluids.

In some aspects, the use of plastic and rubber materials may also contribute to the fluid spraying system's safety. In the event of a leak or spill, these materials may not react with the chemicals or fluids being sprayed, potentially reducing the risk of chemical reactions or corrosive damage.

In some cases, the plastic and rubber materials may also contribute to the fluid spraying system's ease of maintenance. These materials may be easy to clean and may not require special treatments or coatings to maintain their corrosion resistance. This may reduce the time and resources required for system maintenance, potentially enhancing the overall efficiency and cost-effectiveness of the fluid spraying system.

In some aspects, the fluid spraying system may be designed to handle a variety of chemicals, making it versatile for use in different industries. For instance, the system may be used for dispensing chemicals for washing, botanical use, and pest control, among others. The ability to adjust the mixture ratios of different chemicals as they pass through the system, as facilitated by the metering valves, may allow the system to cater to the specific needs or requirements of different industries.

In some cases, the fluid spraying system may be less prone to leaks compared to other systems. This may be due to the design and construction of the system components, such as the pumps, metering valves, and spray gun, which may be made from materials that are resistant to corrosion and wear, such as plastic or rubber. The reduced likelihood of leaks may protect other equipment from corrosive chemicals, potentially extending the lifespan of the equipment and reducing maintenance costs. This feature may be particularly beneficial in industries where the chemicals used are highly corrosive, such as the exterior cleaning industry.

In some embodiments, the fluid spraying system may be designed for exterior cleaning applications. The system's ability to dispense chemicals in different forms, such as a full flow or a mist, may allow it to effectively clean various exterior surfaces. Furthermore, the system's durability, efficiency, and user-friendly operation may make it a suitable solution for the exterior cleaning industry.

In some aspects, the fluid spraying system may be designed to withstand the pressures and corrosive nature of various chemicals. This may ensure the stability and reliability of the system, even when dispensing highly corrosive chemicals. The system's resistance to corrosion may also extend its lifespan, potentially making it a cost-effective solution for various industries.

In some cases, the fluid spraying system may be designed to protect other equipment from corrosive chemicals. The system's reduced likelihood of leaks may prevent corrosive chemicals from coming into contact with other equipment, potentially extending the lifespan of the equipment and reducing maintenance costs. This feature may be particularly beneficial in industries where the chemicals used are highly corrosive, such as the exterior cleaning industry.

In some aspects, the fluid spraying system may be designed with user-friendly operation in mind. The simplicity of the system's operation may require minimal training, potentially allowing users to quickly learn how to operate the system. This ease of operation may be particularly beneficial in industries or applications where multiple users need to operate the system, as it may reduce the time and resources required for training.

In some cases, the fluid spraying system may include intuitive controls for adjusting the flow rate and mixture ratios of the chemicals. These controls may be conveniently located on the manifold or the spray gun, allowing the user to easily adjust the system's operation as needed. The simplicity and intuitiveness of these controls may contribute to the system's user-friendly operation, potentially reducing the likelihood of user errors and enhancing the overall efficiency of the spraying operation.

In some embodiments, the fluid spraying system may include clear and concise instructions for operation and maintenance. These instructions may be provided in a user manual or displayed on the system itself, potentially further simplifying the operation and maintenance of the system. The availability of these instructions may reduce the need for extensive training, potentially allowing users to quickly learn how to operate and maintain the system.

In some aspects, the fluid spraying system may be designed to minimize the likelihood of operational interruptions. For instance, the parallel configuration of the pumps may ensure a continuous and uninterrupted operation of the system, even in the event of a single pump stalling or failing. This feature may further enhance the user-friendly operation of the system, as it may reduce the need for users to troubleshoot and resolve operational issues.

In some cases, the fluid spraying system may include safety features designed to protect the user and the system. These safety features may include, for example, a pressure relief valve to prevent excessive pressure build-up, a thermal overload protector to prevent overheating, and a leak detection system to alert the user of potential leaks. These safety features may contribute to the system's user-friendly operation, as they may provide users with peace of mind and confidence in the system's safe and reliable operation.

In some aspects, the fluid spraying system may offer a range of benefits that enhance its utility across various industries. For instance, the system's ability to prevent stalling, achieved through the parallel configuration of the four pumps, may ensure a continuous and uninterrupted operation. This feature may be particularly beneficial in industries or applications where prolonged spraying operations are required.

In some cases, the fluid spraying system may offer the advantage of a smaller footprint compared to other air pump systems. This may be due to the system's efficient design, which may include the use of a smaller air compressor and the parallel configuration of the pumps. The reduced size of the system may make it more suitable for use in environments with limited space, such as small workshops or mobile units.

In some embodiments, the fluid spraying system may provide significant energy savings. The system's ability to achieve a flow rate of 20 gallons per minute using a 5 cubic feet per minute air compressor may result in lower energy consumption compared to other systems. This reduced energy consumption may result in significant cost savings, particularly in industries or applications where the fluid spraying system is used frequently or continuously.

In some aspects, the fluid spraying system may offer the advantage of user-friendly operation. The simplicity of the system's operation may require minimal training, potentially allowing users to quickly learn how to operate the system. This ease of operation may be particularly beneficial in industries or applications where multiple users need to operate the system, as it may reduce the time and resources required for training.

In some cases, the fluid spraying system may be designed to withstand extended periods of non-use without causing damage to the pump or spray hoses. This feature may provide the user with the flexibility to pause the spraying operation as needed, without the risk of damaging the system. For instance, the user may release the trigger for extended periods during breaks or when moving between different spraying locations, without causing issues such as overheating or pump damage.

In some embodiments, the fluid spraying system may be constructed from materials that are resistant to corrosion and wear, such as plastic or rubber. This may extend the lifespan of the system and, by extension, its overall durability. This durability may make the fluid spraying system a cost-effective solution for various industries and applications.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fluid spraying system, comprising:
four pumps, each of the four pumps having a pump inlet, a pump outlet and an air supply connection;
a plurality of metering valves connected to a metering valve manifold, each metering valve for controlling flow of a chemical;
a pump inlet manifold connected to the pump inlet of each of the four pumps;
a pump outlet manifold connected to the pump outlet of each of the four pumps;
a pump air supply manifold connected to the air supply connection of each of the four pumps; and
a control unit for controlling the air supply to the four pumps.

2. The fluid spraying system of claim 1, wherein the control unit turns the pumps on and off in different configurations to control flow rate of fluid to a spray gun or spray wand.

3. The fluid spraying system of claim 1 including a warning module configured to alert a user if there is a problem with a specific pump.

4. The fluid spraying system of claim 1 wherein the manifold assembly and pumps are constructed of plastic and rubber materials to prevent rusting.

5. The fluid spraying system of claim 1 wherein the system operates using a 5 cubic feet per minute (CFM) air compressor to achieve a flow rate of 20 gallons per minute.

6. The fluid spraying system of claim 1 wherein each metering valve is connected at one end to a container having a specific chemical and at an opposite end to a metering valve manifold connected to the pump inlet manifold.

7. The fluid spraying system of claim 6 wherein the metering valves allow changing of chemical mixtures as they flow through the system, enabling on-demand mixing of solutions.

8. A method of operating a fluid spraying system, comprising:
providing a manifold assembly with four pumps connected in parallel;
supplying air to the four pumps through a pump air supply manifold;
controlling a mixture of different chemicals using a plurality of metering valves connected to the manifold assembly;
directing fluid from the four pumps through a pump outlet manifold; and
controlling air supply to the four pumps using a control unit to adjust fluid flow rate.

9. The method of claim 8 including a circuit for alerting a user if there is a problem with a specific pump using a warning module.

10. The method of claim 8, wherein controlling the mixture of different chemicals comprises connecting each metering valve at one end to a container having a specific chemical and at an opposite end to a metering valve manifold connected to a pump inlet manifold.

11. The method of claim 10, further comprising changing chemical mixtures on-demand as they flow through the system.

12. The method of claim 8, wherein supplying air to the four pumps comprises using a 5 cubic feet per minute (CFM) air compressor to achieve a flow rate of 20 gallons per minute.

13. The method of claim 8, further comprising turning the pumps on and off in different configurations to control flow rate of fluid to a spray gun or spray wand.

14. The method of claim 13, wherein controlling air supply to the four pumps comprises coordinating power to each pump based on user needs and internal problems with the system.

15. A fluid spraying apparatus, comprising:
a manifold assembly;
four air-operated double diaphragm pumps connected in parallel to the manifold assembly;
a plurality of metering valves connected to the manifold assembly, each metering valve for controlling a mixture of different chemicals;
a pump inlet manifold;
a pump outlet manifold; and
a pump air supply manifold
wherein a spray gun is attachable to the pump outlet manifold.

16. The fluid spraying apparatus of claim 15 including a control unit configured to control air supply to the four air-operated double diaphragm pumps.

17. The fluid spraying apparatus of claim 16 wherein the control unit turns the pumps on and off in different configurations to control flow rate of fluid to the spray gun.

18. The fluid spraying apparatus of claim 15 wherein each metering valve is connected at one end to a container having a specific chemical and at an opposite end to a metering valve manifold connected to the pump inlet manifold.

19. The fluid spraying apparatus of claim 18 wherein the metering valves allow changing of chemical mixtures as they flow through the apparatus, enabling on-demand mixing of solutions.

20. The fluid spraying apparatus of claim 19 wherein the apparatus operates using a 5 cubic feet per minute (CFM) air compressor to achieve a flow rate of 20 gallons per minute.
